(19) United States
(12) Patent Application Publication
(10) Pub. No.: US 2026/0288707 A1
(43) Pub. Date: Sep. 24, 2026

(54) SYSTEM FOR GENERATING RESPONSES WITH CITATION OF REFERENCES

(71) Applicant: SoftBank Group Corp., Tokyo (JP)

(72) Inventor: Yuka TODOKORO, Tokyo (JP)

(21) Appl. No.: 19/567,278

(22) Filed: Mar. 16, 2026

Related U.S. Application Data
(60) Provisional application No. 63/775,302, filed on Mar. 21, 2025.

(51) Int. Cl. G06F 16/242

(52) U.S. Cl. CPC G06F 16/243

(57) ABSTRACT

The present disclosure relates to a system that generates an answer based on data from a reliable information source in response to a user's question input in natural language, and clearly indicates reference literature used in the process of arriving at the answer. The system includes a user input unit, a natural language processing unit, an information search unit, an information evaluation unit, an answer generation unit, and a reference literature presentation unit, and a user inputs a question through a smartphone or a personal computer. The natural language processing unit analyzes the question, the information search unit collects related literature, the information evaluation unit evaluates reliability, and the answer generation unit creates a summary. The reference literature presentation unit clearly indicates the information source, enabling the user to confirm the validity of the information.

### CROSS-REFERENCE TO RELATED APPLICATION

This application claims the benefit of priority from U.S. Provisional Patent Application No. 63/775302, filed on Mar. 21, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to improve the precision and reliability of information in an interactive AI system using natural language processing. Specifically, there is a problem in that answers probabilistically generated by conventional interactive AI systems often include information lacking in accuracy, making it difficult for a user to determine the validity thereof by themselves. To solve this problem, the present disclosure aims to make it easier for a user to confirm the validity of information by generating an answer based on data from a reliable information source in response to a user's question, and by clearly indicating reference literature used in the process of arriving at the answer. This makes it possible to improve the accuracy of decision-making in business and to provide an environment where a user can utilize an AI system with confidence. Furthermore, by imposing constraints on specific databases or resources, the reliability of information can be further enhanced, and the provision of misinformation can be prevented. In this way, a user can obtain more accurate and reliable information, and can effectively solve problems in the business use of an AI system.

As a means for solving the problem, the present disclosure provides a system that can receive a user's question input in natural language, analyze the question to search for related information, generate an answer based on the selected information, and further present reference literature that led to the answer. This system includes a user input unit, a natural language processing unit, an information search unit, an information evaluation unit, an answer generation unit, and a reference literature presentation unit. The user input unit receives a question input in natural language, and the natural language processing unit analyzes the question to extract keywords. The information search unit searches for a reliable information source based on the extracted keywords, and the information evaluation unit evaluates the searched information based on reliability and relevance. The answer generation unit generates an answer to the user's question based on the evaluated information, and the reference literature presentation unit clearly indicates the information source or reference literature that led to the answer. This makes it easier for a user to confirm the validity of information, and makes it possible to improve the accuracy of decision-making in business. Furthermore, by imposing constraints on specific databases or resources, the reliability of information can be further enhanced, and the provision of misinformation can be prevented. In this way, a user can obtain more accurate and reliable information, and can effectively solve problems in the business use of an AI system.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for generating a response while presenting reference literature.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5 th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

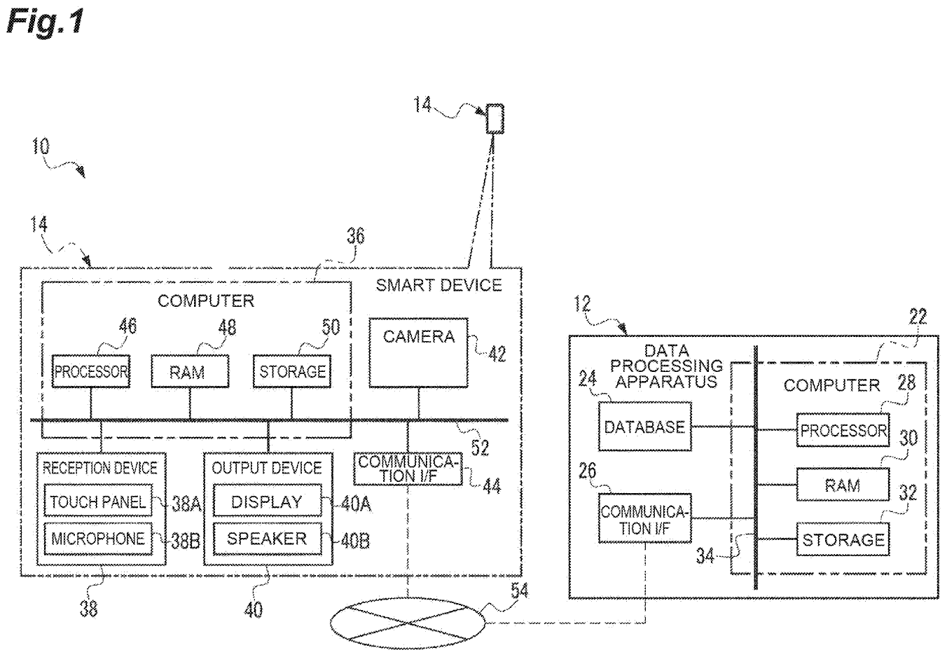

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

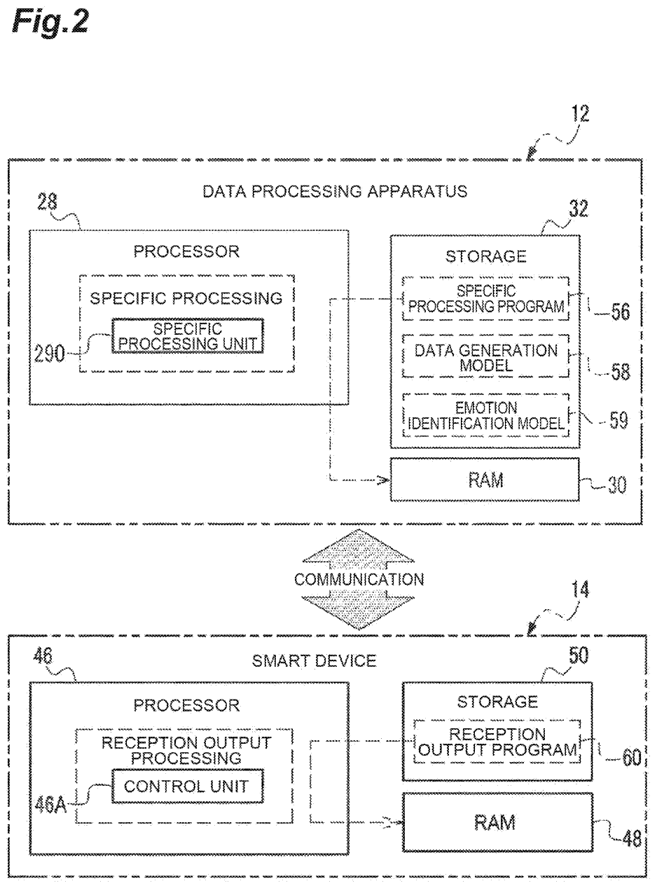

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is realized by both a server and a terminal, and how the function of each unit is realized in each device is shown below.

First, a user input unit is implemented in a terminal. The terminal provides an interface for a user to input a question in natural language. The user input unit may be configured by, for example, the reception device 38. Specifically, a smartphone, a tablet, a personal computer, and further a voice assistant device and the like can be considered. These devices enable a user to input a question by text or voice using a touch screen, a keyboard, or a microphone. For example, in a smartphone application, a user can input a question into a text box on the screen or press a voice input button to input the question by voice. In the case of voice input, the terminal converts the voice into text using speech recognition technology and transmits the text to the server.

Next, a natural language processing unit is implemented in a server. The natural language processing unit may be configured by, for example, the specific processing unit 290, the specific processing program 56, the data generation model 58, and the emotion identification model 59. The server receives a user's question transmitted from the terminal and performs analysis using natural language processing technology. This analysis includes morphological analysis, syntactic analysis, semantic analysis, and further contextual analysis. For example, in order to extract important keywords from a question sentence, words are divided using morphological analysis, and the structure of the sentence is understood using syntactic analysis. Furthermore, through semantic analysis, the intent of the question can be understood, and by using contextual analysis, past dialogue history and related information can be taken into consideration. This makes it possible to more accurately grasp the intent behind the user's question.

The analysis processing in the natural language processing unit is not limited to mere phrase replacement or dictionary lookup, but includes an embedding process of mapping the input question sentence to a multidimensional vector space. Specifically, the natural language processing unit converts the question sentence into a fixed-length vector representation using a neural network based on the Transformer architecture. This vector representation expresses the semantic proximity of words as a numerical array of hundreds to thousands of dimensions, which is data in a format that is practically impossible to calculate in the human mind. This makes it possible to identify semantically similar concepts (Semantic Similarity) by mathematical distance calculation (cosine similarity, etc.) even if the keywords do not completely match.

Furthermore, the natural language processing unit performs query expansion on the extracted keywords by referring to a domain-specific ontology dictionary. For example, for an input of “AI”, subordinate concepts and related terms such as “machine learning”, “deep learning”, and “neural network” are automatically added to reconstruct the search query. This process is executed at high speed using lightweight dictionary data expanded in a dedicated cache area on the RAM 30, optimizing the number of accesses to an external database via the communication I/F 26, and achieving the technical effect of suppressing network bandwidth consumption.

An information search unit is also implemented in the server. The information search unit may be configured by, for example, the specific processing unit 290, the specific processing program 56, the data generation model 58, and the emotion identification model 59. This unit has a role of searching for a reliable information source based on keywords extracted by the natural language processing unit. Specifically, it accesses academic paper databases, specialized information repositories, and further industry-specific databases to collect related literature. For example, when searching for a paper including the latest research results in a specific field, a search can be performed targeting proceedings of a specific journal or conference. Also, by using an industry-specific database, it is possible to grasp the latest trends and best practices in a specific technical field.

An information evaluation unit is also arranged in the server. The information evaluation unit may be configured by, for example, the specific processing unit 290, the specific processing program 56, the data generation model 58, and the emotion identification model 59. This unit evaluates the searched information based on reliability and relevance. The evaluation criteria include the source of the information, the year of publication, the reliability of the author, the number of citations, and further the update frequency and influence of the information. For example, a paper with the latest publication year and by a prominent researcher is highly evaluated. Also, a paper with a large number of citations is determined to be highly evaluated by other researchers and is considered to have high reliability. Furthermore, when the update frequency of information is high, it is highly likely that the information is up-to-date, and it is determined that the reliability is high.

The evaluation of information by the information evaluation unit is executed based on the following specific scoring algorithm. The information evaluation unit calculates a reliability score S for each searched document D. Here, S=w1×C+w2×(1/Y)+w3×A. C is the number of citations normalized by the field average, Y is the difference between the current year and the publication year (however, if the difference is 0, it is set to 1), A is a rank value based on the author's h-index, and w1, w2, and w3 are weighting coefficients dynamically adjusted by the system.

The weighting coefficient w is automatically changed based on an intent tag identified by the natural language processing unit according to the attribute of the user's question (whether “latest” is sought or “basic theory” is sought). For example, in the case of a question asking for “latest trends”, the value of w2 (freshness of information) is increased. Thus, unlike literature evaluation subjectively performed by humans, the present invention instantaneously filters optimal information from a vast amount of literature data by arithmetic processing based on objective numerical parameters, solving the technical problem of improving the information retrieval accuracy of a computer.

An answer generation unit may be configured by, for example, the specific processing unit 290, the specific processing program 56, the data generation model 58, and the emotion identification model 59. The answer generation unit is implemented in the server and generates an answer to a user's question based on the evaluated information. In this process, an answer is created in a form that includes a summary of the information and important points. For example, specific content such as “As a paper on AI technology published in 2023, there is a study by author X, which focuses on Y technology” is generated. The answer generation unit aims to integrate information obtained from a plurality of information sources and provide it in a form that is most relevant and easy for a user to understand.

The answer generation unit is equipped with verification logic for suppressing “plausible lies (hallucinations)” which are a problem specific to generative AI (Large Language Model). The answer generation unit extracts fact propositions included in the generated answer sentence and performs textual entailment recognition with the highly reliable literature data acquired by the information search unit. If the generated answer contradicts the content of the reference literature, or if there is no basis in the reference literature, the answer generation unit discards the generation of the relevant part and performs generation again, or sets a flag indicating that the basis is unknown. By this processing, the output of the generative AI that performs output probabilistically is constrained by deterministic basis data, ensuring reliability that can withstand business use at the hardware level.

A reference literature presentation unit is implemented in the server and clearly indicates the information source or reference literature that led to the generated answer. The reference literature presentation unit may be configured by, for example, the specific processing unit 290, the specific processing program 56, the data generation model 58, and the emotion identification model 59. This unit presents detailed information such as the title of the paper, the author's name, the year of publication, the journal name, and further a DOI (Digital Object Identifier) to a user. For example, it enables a user to confirm the details of the reference literature in order to confirm the validity of the answer. This allows a user to track the source of the information and obtain more detailed information as needed.

Finally, the generated answer and reference literature information are transmitted from the server to the terminal and provided to the user through the interface of the terminal. The terminal displays the information in a visually easy-to-understand format so that a user can easily browse the answer. For example, by organizing the answer using bullet points or charts and providing the reference literature in a link format, a user can easily access it. In this way, the server and the terminal can cooperate to carry out the present disclosure.

### System Configuration

The system according to the present embodiment includes a user input unit, a natural language processing unit, an information search unit, an information evaluation unit, an answer generation unit, and a reference literature presentation unit. The user input unit provides an interface for a user to input a question in natural language. This interface is implemented in a terminal such as a smartphone, a tablet, a personal computer, or a voice assistant device, and the user can input a question by text or voice through these devices. For example, in a smartphone application, a user can input a question into a text box on the screen or press a voice input button to input the question by voice. In the case of voice input, the terminal converts the voice into text using speech recognition technology and transmits the text to the server.

The natural language processing unit is implemented in a server, receives a user's question transmitted from the terminal, and performs analysis using natural language processing technology. This analysis includes morphological analysis, syntactic analysis, semantic analysis, and contextual analysis. In morphological analysis, a question sentence is divided into words, and the part of speech of each word is identified. In syntactic analysis, the structure of the sentence is understood, and relationships such as subject, predicate, and object are clarified. In semantic analysis, the meaning of the sentence is understood, and the intent of the question is grasped. In contextual analysis, past dialogue history and related information are taken into consideration, and the background of the question is understood. For example, in response to a question “Please tell me about the latest AI technology,” these analyses are performed to identify the latest research and trends related to AI technology.

The information search unit has a role of searching for a reliable information source based on keywords extracted by the natural language processing unit. Specifically, it accesses academic paper databases, specialized information repositories, and industry-specific databases to collect related literature. For example, when searching for a paper including the latest research results in a specific field, a search can be performed targeting proceedings of a specific journal or conference. Also, by using an industry-specific database, it is possible to grasp the latest trends and best practices in a specific technical field. Furthermore, the information search unit implements an algorithm for optimizing a search query and quickly obtaining more relevant information.

The information evaluation unit evaluates the searched information based on reliability and relevance. The evaluation criteria include the source of the information, the year of publication, the reliability of the author, the number of citations, and the update frequency and influence of the information. For example, a paper with the latest publication year and by a prominent researcher is highly evaluated. Also, a paper with a large number of citations is determined to be highly evaluated by other researchers and is considered to have high reliability. Furthermore, when the update frequency of information is high, it is highly likely that the information is up-to-date, and it is determined that the reliability is high. The information evaluation unit uses these criteria to ensure the quality of the information provided to the user.

The answer generation unit generates an answer to the user's question based on the evaluated information. In this process, an answer is created in a form that includes a summary of the information and important points. For example, specific content such as “As a paper on AI technology published in 2023, there is a study by author X, which focuses on Y technology” is generated. The answer generation unit aims to integrate information obtained from a plurality of information sources and provide it in a form that is most relevant and easy for a user to understand. A specific example of a prompt sentence to be read into a generative AI is “Please create a summary based on reliable information about the latest AI technology.”

The reference literature presentation unit clearly indicates the information source or reference literature that led to the generated answer. This unit presents detailed information such as the title of the paper, the author's name, the year of publication, the journal name, and a DOI to a user. For example, it enables a user to confirm the details of the reference literature in order to confirm the validity of the answer. This allows a user to track the source of the information and obtain more detailed information as needed. The reference literature presentation unit provides information in a visually easy-to-understand format so that a user can confirm the reliability of the information by themselves.

### Implementation Steps

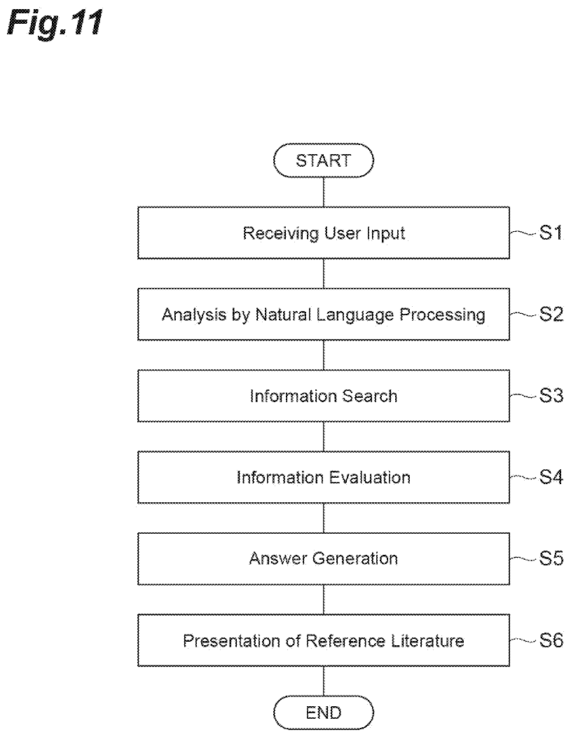

### Step 1: Receiving User Input (See Step S1 in FIG. 11)

Via the user input unit, a user inputs a question in natural language. In this step, a terminal such as a smartphone, a tablet, a personal computer, or a voice assistant device is used, and the question can be input by text or voice. For example, in a smartphone application, a user can input a question into a text box on the screen or press a voice input button to input the question by voice. In the case of voice input, the terminal converts the voice into text using speech recognition technology and transmits the text to the server.

### Step 2: Analysis by Natural Language Processing (See Step S2 in FIG. 11)

The natural language processing unit is implemented in a server, receives a user's question transmitted from the terminal, and performs analysis using natural language processing technology. This analysis includes morphological analysis, syntactic analysis, semantic analysis, and contextual analysis. For example, in response to a question “Please tell me about the latest AI technology,” these analyses are performed to identify the latest research and trends related to AI technology.

### Step 3: Information Search (See Step S3 in FIG. 11)

The information search unit has a role of searching for a reliable information source based on keywords extracted by the natural language processing unit. Specifically, it accesses academic paper databases, specialized information repositories, and industry-specific databases to collect related literature. For example, when searching for a paper including the latest research results in a specific field, a search can be performed targeting proceedings of a specific journal or conference.

### Step 4: Information Evaluation (See Step S4 in FIG. 11)

The information evaluation unit evaluates the searched information based on reliability and relevance. The evaluation criteria include the source of the information, the year of publication, the reliability of the author, the number of citations, and the update frequency and influence of the information. For example, a paper with the latest publication year and by a prominent researcher is highly evaluated. Also, a paper with a large number of citations is determined to be highly evaluated by other researchers and is considered to have high reliability.

### Step 5: Answer Generation (See Step S5 in FIG. 11)

The answer generation unit generates an answer to the user's question based on the evaluated information. In this process, an answer is created in a form that includes a summary of the information and important points. For example, specific content such as “As a paper on AI technology published in 2023, there is a study by author X, which focuses on Y technology” is generated. A specific example of a prompt sentence to be read into a generative AI is “Please create a summary based on reliable information about the latest AI technology.”

### Step 6: Presentation of Reference Literature (See Step S6 in FIG. 11)

The reference literature presentation unit clearly indicates the information source or reference literature that led to the generated answer. This unit presents detailed information such as the title of the paper, the author's name, the year of publication, the journal name, and a DOI to a user. For example, it enables a user to confirm the details of the reference literature in order to confirm the validity of the answer. This allows a user to track the source of the information and obtain more detailed information as needed.

### Specific Use Case

For example, when a certain researcher tries to collect information on the latest AI technology, the system of the present disclosure can be used. The researcher uses a smartphone or a personal computer to input a question in natural language to the user input unit, such as “Please tell me about papers on the latest AI technology.” This input can be made by either voice input or text input. In the case of voice input, the voice is converted into text by speech recognition technology and transmitted to the server.

The natural language processing unit analyzes the received question and extracts important keywords. Here, keywords such as “AI technology,” “latest,” and “paper” are identified. Based on these keywords, the information search unit searches for a reliable information source. Specifically, it accesses academic paper databases and specialized information repositories to collect related literature. For example, when searching for a paper including the latest research results on AI technology, a search can be performed targeting proceedings of a specific journal or conference.

The information evaluation unit evaluates the searched information based on reliability and relevance. The evaluation criteria include the source of the information, the year of publication, the reliability of the author, and the number of citations. For example, a paper with the latest publication year and by a prominent researcher is highly evaluated. Also, a paper with a large number of citations is determined to be highly evaluated by other researchers and is considered to have high reliability.

The answer generation unit generates an answer to the researcher's question based on the evaluated information. In this process, an answer is created in a form that includes a summary of the information and important points. For example, specific content such as “As a paper on AI technology published in 2023, there is a study by author X, which focuses on Y technology” is generated. A specific example of a prompt sentence to be read into a generative AI is “Please create a summary based on reliable information about the latest AI technology.”

The reference literature presentation unit clearly indicates the information source or reference literature that led to the generated answer. It presents detailed information such as the title of the paper, the author's name, the year of publication, the journal name, and a DOI to the researcher. This allows the researcher to track the source of the information and obtain more detailed information as needed. Based on this information, the researcher can grasp the latest trends in AI technology and utilize them in their research activities.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is designed to support the operation of an autonomous vehicle and includes a sensor unit, a data analysis unit, and a decision support unit.

First, a sensor unit will be described. The sensor unit includes a plurality of sensors mounted on an autonomous vehicle, and these include a LIDAR, a camera, a GPS, and a weather sensor. The LIDAR measures the distance and shape of surrounding objects with high accuracy using laser light. This technology allows the vehicle to grasp the distance to a vehicle or a pedestrian ahead in real time and evaluate the risk of a collision. For example, the LIDAR is capable of high-accuracy measurement even at night or in bad weather, and supports safe operation even in situations with poor visibility. The camera is used to recognize road signs and colors of traffic lights. For example, the camera can detect a red light and issue an instruction to stop the vehicle. Also, it reads road signs and provides information such as speed limits and no-entry to the driving system. The GPS identifies the accurate position of the vehicle and plans a route in cooperation with a navigation system. For example, the GPS can calculate the shortest route to a destination and guide the vehicle. Furthermore, the weather sensor detects weather conditions such as rain and fog and is used to adjust driving conditions. For example, when it is raining, the speed of the vehicle can be automatically reduced.

Next, a data analysis unit will be described. The data analysis unit is designed to analyze data obtained from the sensor unit. This unit uses natural language processing technology and machine learning algorithms to evaluate road congestion, changes in traffic regulations, and effects of weather, and to identify factors that affect the operation of the vehicle. For example, by combining past traffic data and real-time sensor data, it is possible to predict the flow of traffic. This allows the vehicle to avoid traffic jams and realize efficient operation. Also, by analyzing weather data, it is possible to evaluate the impact of rain and snow on driving. This makes it possible to reflect it in the vehicle's operation plan. Furthermore, the data analysis unit can monitor the state of the vehicle and issue a warning to the driving system when an abnormality is detected. For example, when the tire pressure has dropped or an engine abnormality has been detected, it can notify the driver and prompt an appropriate response.

Finally, a decision support unit will be described. The decision support unit proposes an optimal operation route or driving method based on the analysis result of the data analysis unit. This unit uses a generative AI to evaluate a plurality of options and generate the most appropriate proposal. For example, in order to avoid congestion, it can propose a route that takes a back road instead of a main road. Also, in bad weather, it proposes to reduce speed or to avoid a specific road. This proposal is presented to the driver through the vehicle's display or a voice assistant. For example, specific instructions such as “Please turn right at the next intersection” or “Please reduce the speed to 50 kilometers per hour” are provided. Furthermore, when new information is obtained during operation, the decision support unit can update the proposal in real time and provide the latest information to the driver. This allows the vehicle to always maintain optimal operation.

In this way, the present disclosure enables an autonomous vehicle to flexibly respond to road conditions and weather conditions that change in real time, and to realize safe and efficient operation. This is expected to contribute to a reduction in traffic accidents and a reduction in operation costs.

### System Configuration

The system according to the present embodiment includes a sensor unit, a data analysis unit, and a decision support unit. The sensor unit includes a plurality of sensors mounted on an autonomous vehicle, and includes a LIDAR, a camera, a GPS, and a weather sensor. The LIDAR measures the distance and shape of surrounding objects with high accuracy using laser light. For example, the LIDAR can grasp the distance to a vehicle or a pedestrian ahead in real time and evaluate the risk of a collision. It is capable of high-accuracy measurement even at night or in bad weather, and supports safe operation even in situations with poor visibility. The camera is used to recognize road signs and colors of traffic lights. For example, the camera can detect a red light and issue an instruction to stop the vehicle. Also, it reads road signs and provides information such as speed limits and no-entry to the driving system. The GPS identifies the accurate position of the vehicle and plans a route in cooperation with a navigation system. For example, the GPS can calculate the shortest route to a destination and guide the vehicle. Furthermore, the weather sensor detects weather conditions such as rain and fog and is used to adjust driving conditions. For example, when it is raining, the speed of the vehicle can be automatically reduced.

The data analysis unit is designed to analyze data obtained from the sensor unit. This unit uses natural language processing technology and machine learning algorithms to evaluate road congestion, changes in traffic regulations, and effects of weather, and to identify factors that affect the operation of the vehicle. For example, by combining past traffic data and real-time sensor data, it is possible to predict the flow of traffic. This allows the vehicle to avoid traffic jams and realize efficient operation. Also, by analyzing weather data, it is possible to evaluate the impact of rain and snow on driving. This makes it possible to reflect it in the vehicle's operation plan. Furthermore, the data analysis unit can monitor the state of the vehicle and issue a warning to the driving system when an abnormality is detected. For example, when the tire pressure has dropped or an engine abnormality has been detected, it can notify the driver and prompt an appropriate response.

The decision support unit proposes an optimal operation route or driving method based on the analysis result of the data analysis unit. This unit uses a generative AI to evaluate a plurality of options and generate the most appropriate proposal. For example, in order to avoid congestion, it can propose a route that takes a back road instead of a main road. Also, in bad weather, it proposes to reduce speed or to avoid a specific road. This proposal is presented to the driver through the vehicle's display or a voice assistant. For example, specific instructions such as “Please turn right at the next intersection” or “Please reduce the speed to 50 kilometers per hour” are provided. Furthermore, when new information is obtained during operation, the decision support unit can update the proposal in real time and provide the latest information to the driver. A specific example of a prompt sentence to be read into a generative AI is “Please propose an optimal operation route based on the current road conditions and weather information.”

In this way, the present disclosure enables an autonomous vehicle to flexibly respond to road conditions and weather conditions that change in real time, and to realize safe and efficient operation. This is expected to contribute to a reduction in traffic accidents and a reduction in operation costs.

### Implementation Steps

### Step 1: Data Collection

The sensor unit mounted on the autonomous vehicle collects surrounding environmental information in real time using a LIDAR, a camera, a GPS, and a weather sensor. The LIDAR measures the distance to a vehicle or a pedestrian ahead with high accuracy using laser light, and supports safe operation in situations with poor visibility even at night or in bad weather. The camera recognizes road signs and colors of traffic lights, and can detect a red light and issue an instruction to stop the vehicle. The GPS identifies the accurate position of the vehicle and calculates the shortest route to a destination in cooperation with a navigation system. The weather sensor detects weather conditions such as rain and fog and is used to adjust driving conditions. For example, when it is raining, the speed of the vehicle can be automatically reduced.

### Step 2: Data Analysis

The data analysis unit analyzes the data obtained from the sensor unit. It uses natural language processing technology and machine learning algorithms to evaluate road congestion, changes in traffic regulations, and effects of weather, and to identify factors that affect the operation of the vehicle. It predicts the flow of traffic by combining past traffic data and real-time sensor data, and realizes efficient operation to avoid traffic jams. Also, by analyzing weather data, it is possible to evaluate the impact of rain and snow on driving and reflect it in the operation plan. Furthermore, it can monitor the state of the vehicle and issue a warning to the driving system when an abnormality is detected.

### Step 3: Decision Support

The decision support unit proposes an optimal operation route or driving method based on the analysis result of the data analysis unit. It uses a generative AI to evaluate a plurality of options and generate the most appropriate proposal. For example, in order to avoid congestion, it can propose a route that takes a back road instead of a main road. Also, in bad weather, it proposes to reduce speed or to avoid a specific road. This proposal is presented to the driver through the vehicle's display or a voice assistant. A specific example of a prompt sentence to be read into a generative AI is “Please propose an optimal operation route based on the current road conditions and weather information.”

### Step 4: Presentation of Proposal

The proposed operation route or driving method is presented to the driver through the vehicle's display or a voice assistant. For example, specific instructions such as “Please turn right at the next intersection” or “Please reduce the speed to 50 kilometers per hour” are provided. When new information is obtained during operation, the proposal can be updated in real time and the latest information can be provided to the driver. This allows the vehicle to always maintain optimal operation.

### Specific Use Case

For example, the system of the present disclosure is applied to an autonomous vehicle traveling in the center of a certain city. This vehicle collects surrounding environmental information in real time using a sensor unit. The LIDAR measures the distance to a vehicle or a pedestrian ahead with high accuracy, and the camera recognizes road signs and colors of traffic lights. The GPS identifies the accurate position of the vehicle, and the weather sensor detects weather conditions such as rain and fog. This data is sent to a data analysis unit and analyzed using natural language processing technology and machine learning algorithms.

The data analysis unit evaluates road congestion and changes in traffic regulations, and considering the effects of weather, identifies factors that affect the operation of the vehicle. For example, it predicts the flow of traffic by combining past traffic data and real-time sensor data, and realizes efficient operation to avoid traffic jams. Also, by analyzing weather data, it is possible to evaluate the impact of rain and snow on driving and reflect it in the operation plan.

The decision support unit proposes an optimal operation route or driving method based on the analysis result of the data analysis unit. It uses a generative AI to evaluate a plurality of options and generate the most appropriate proposal. For example, in order to avoid congestion, it can propose a route that takes a back road instead of a main road. Also, in bad weather, it proposes to reduce speed or to avoid a specific road. This proposal is presented to the driver through the vehicle's display or a voice assistant. A specific example of a prompt sentence to be read into a generative AI is “Please propose an optimal operation route based on the current road conditions and weather information.”

The proposed operation route or driving method is presented to the driver through the vehicle's display or a voice assistant. For example, specific instructions such as “Please turn right at the next intersection” or “Please reduce the speed to 50 kilometers per hour” are provided. When new information is obtained during operation, the proposal can be updated in real time and the latest information can be provided to the driver. This allows the vehicle to always maintain optimal operation.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

The data generation model 58 may be implemented as a lightweight model not only on the server (data processing apparatus 12) side but also on the terminal side (edge side) such as the smart device 14 or the smart glasses 214. In this case, the parameters of the model are quantized, for example, from 32-bit floating point to 8-bit or 4-bit integer, and the model size is compressed. This saves the capacity of the storage 50 of the terminal, reduces the computational load on the processor 46, and suppresses battery consumption.

Furthermore, the system executes hybrid inference that distributes processing according to the complexity of the question. For simple questions (e.g., fact-checking), the lightweight model on the terminal side responds immediately, and for questions requiring complex inference, they are transmitted to the high-performance model on the server side. This distribution determination is made in real time by the control unit 46A based on the number of tokens of the input data and the communication environment (bandwidth, delay) of the terminal. This optimizes the user experience while minimizing the impact of network delay.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

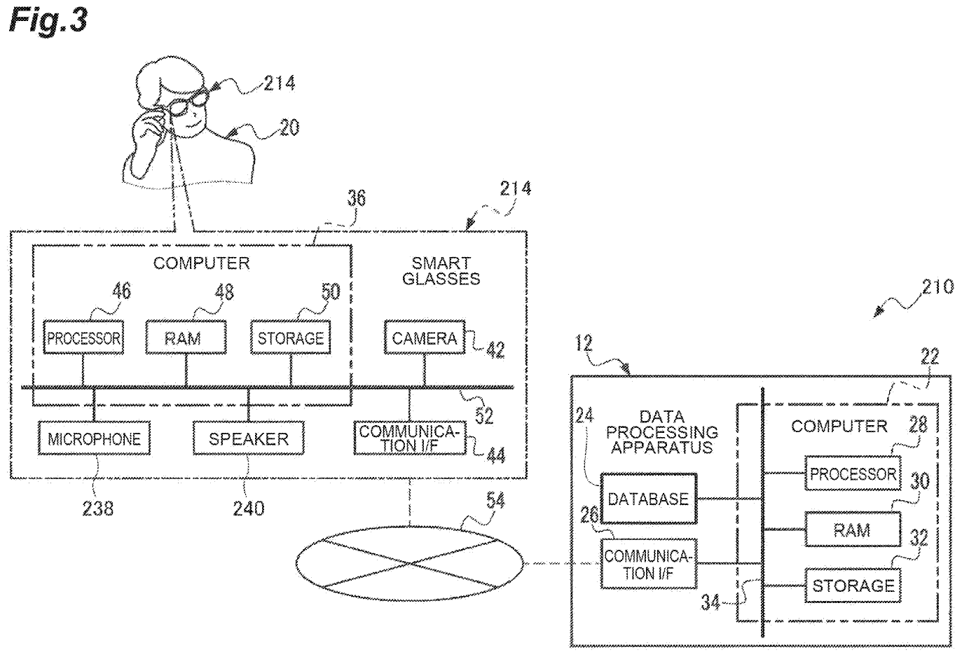

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

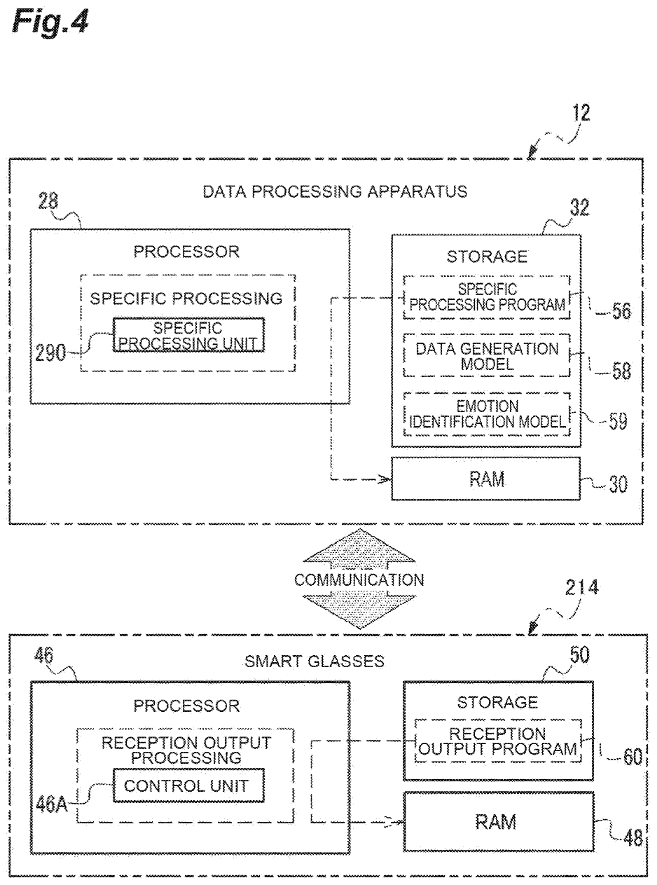

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

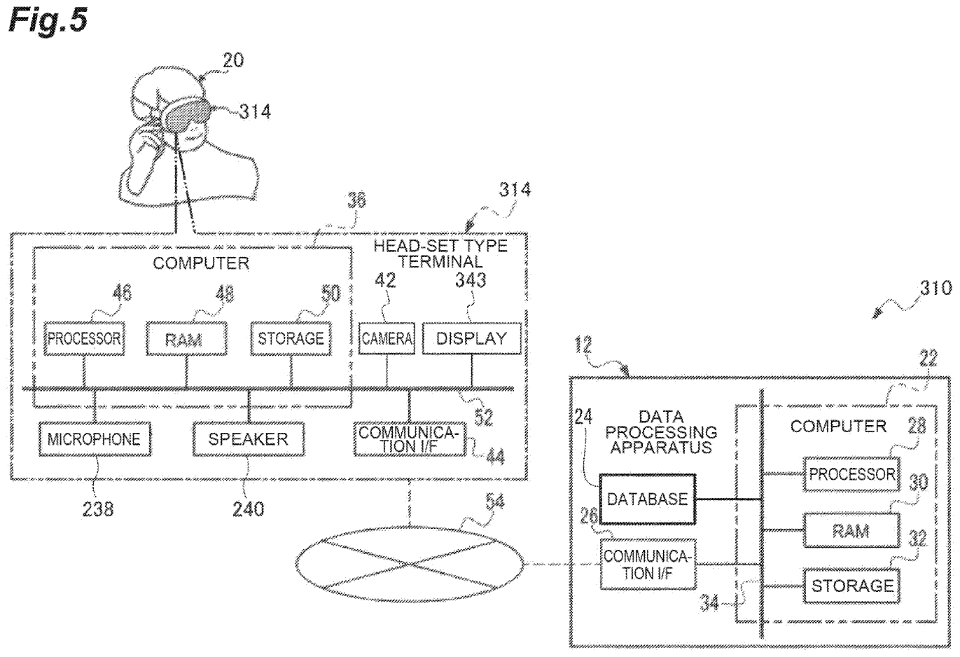

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

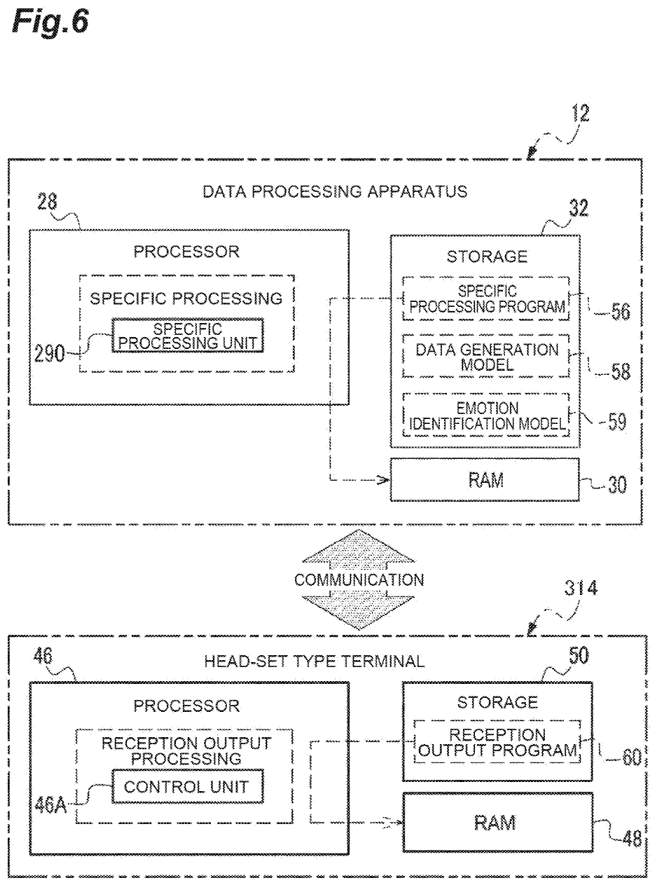

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

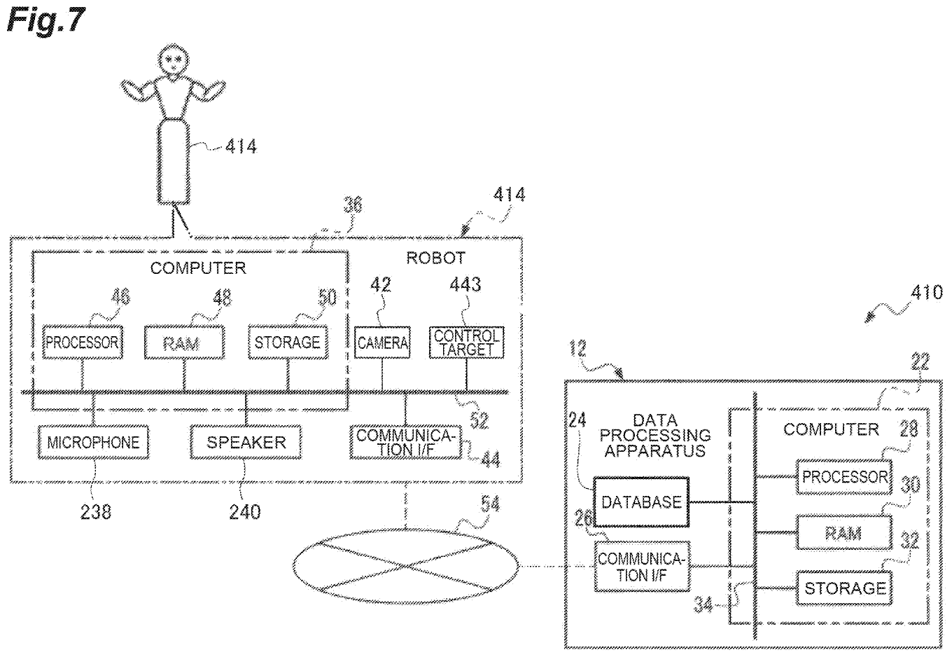

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

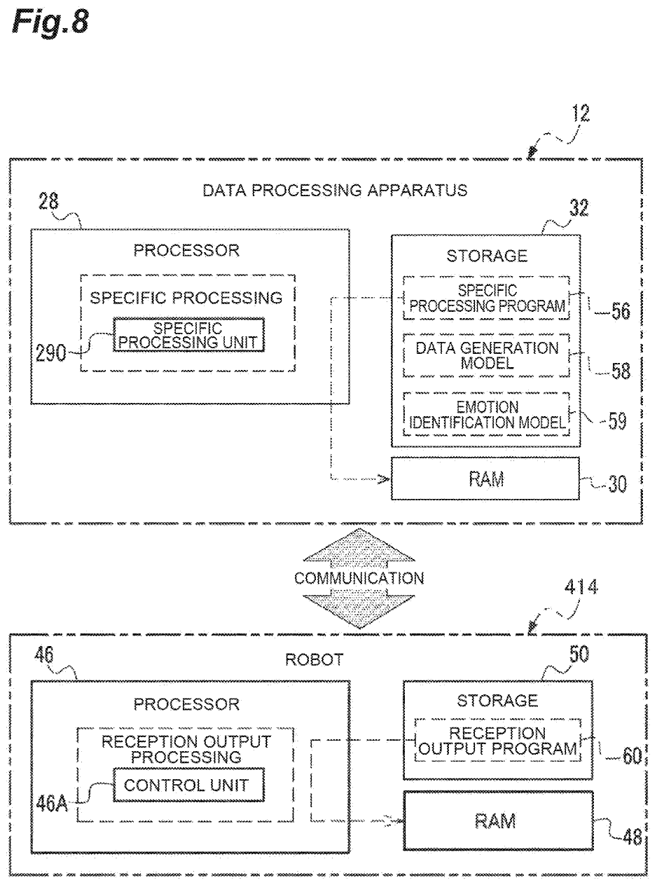

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

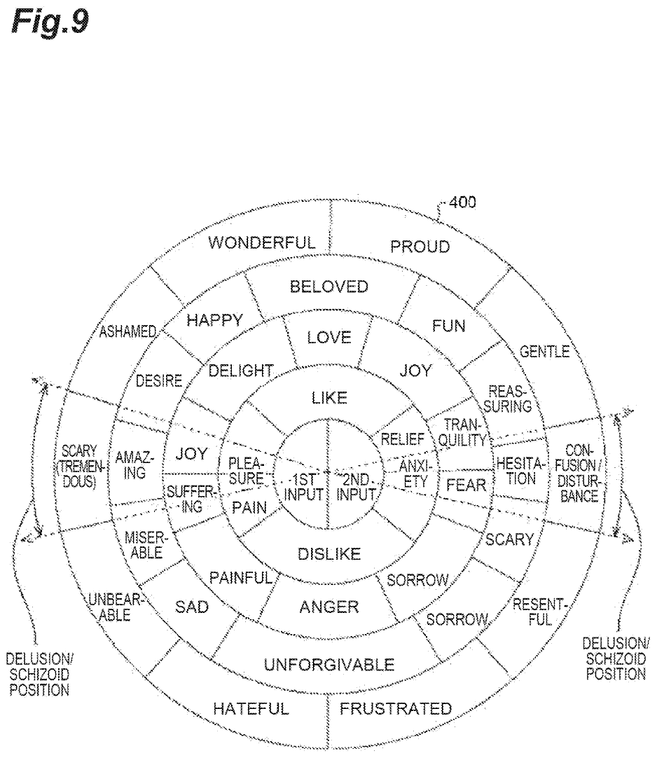

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

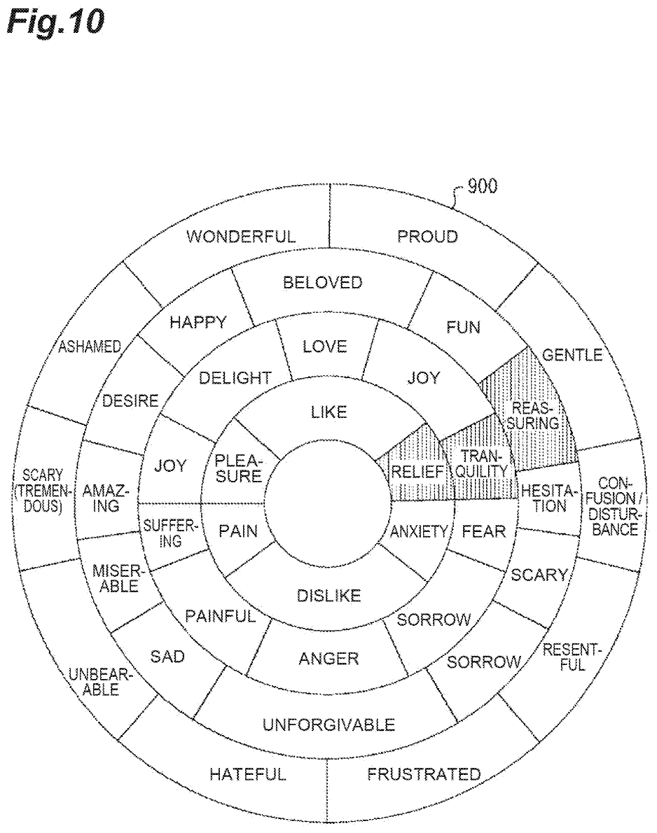

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

The emotion value identified by the emotion identification model 59 is not only used for displaying information but is also directly used for changing physical actuator control parameters of the robot 414. For example, when it is determined that the user's emotion is in a negative region (lower side of the emotion map) such as “anger” or “anxiety”, the specific processing unit 290 generates a command to adjust the PID control gain (proportional-integral-derivative gain) of the motors driving the arms and movement mechanism of the robot 414 and shift to a “safety mode” that suppresses the acceleration and maximum speed of the operation.

Conversely, when the user's emotion is in “joy” or “excitement”, control is performed to change the brightness pattern of the LED at a high frequency or increase the response speed of the operation. Thus, the emotion identification in the present disclosure functions as an input variable for dynamically transforming the physical behavior of a mechanical system, not just abstract classification, and has the technical effect of enhancing safety in human-machine interaction.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system for supporting operation of an autonomous vehicle, comprising a sensor unit, a data analysis unit, and a decision support unit, wherein the sensor unit includes a LIDAR, a camera, a GPS, and a weather sensor, and has a function of detecting road conditions, traffic regulations, weather information, and a state of the vehicle in real time, the data analysis unit has a function of analyzing data obtained from the sensor unit using natural language processing technology and machine learning algorithms, evaluating road congestion, changes in traffic regulations, and effects of weather, and identifying factors that affect operation of the vehicle, and the decision support unit has a function of proposing an optimal operation route or driving method based on an analysis result and presenting the proposal to a driving system of the vehicle.

The system, wherein the sensor unit measures a distance and a shape of a surrounding object with high accuracy using the LIDAR, recognizes a color of a road sign or a traffic light using the camera, identifies an accurate position of the vehicle using the GPS, and detects a weather condition such as rain or fog using the weather sensor.

The system, wherein the decision support unit evaluates a plurality of options using a generative AI, generates a most appropriate operation route or driving method, and provides an instruction to a driver through a display or a voice assistant of the vehicle.

A response generation system comprising: circuitry; and a display, wherein the circuitry is configured to: receive a question input from a user in natural language; analyze the question; search for related information; generate an answer to the question based on the searched information; and control the display to present reference literature that served as a basis for generating the answer to the user.

The system, wherein the circuitry is configured to: analyze the question to extract keywords; search for the related information based on the extracted keywords; evaluate the searched information based on reliability and relevance; generate the answer based on the evaluated information; and control the display to present information source corresponding to the evaluated information that served as a basis for generating the answer to the user.

The system, wherein the circuitry is configured to: access a predetermined paper database or information repository to collect related literature; select the literature based on at least one of a source of the literature, a year of publication, reliability of an author, and a number of citations; summarize the selected literature; generate the answer based on the summarized content; and control the display to present at least one of a title of the literature, an author's name, a year of publication, and a journal name.

A response generation method comprising: receiving a question input from a user in natural language; analyzing the question; searching for related information; generating an answer to the question based on the searched information; and controlling a display to present reference literature that served as a basis for generating the answer to the user.

1. A response generation system comprising:
circuitry; and
a display,
wherein the circuitry is configured to:
receive a question input from a user in natural language;
analyze the question;
search for related information;
generate an answer to the question based on the searched information; and
control the display to present reference literature that served as a basis for generating the answer to the user.

2. The system according to claim 1,
wherein the circuitry is configured to:
analyze the question to extract keywords;
search for the related information based on the extracted keywords;
evaluate the searched information based on reliability and relevance;
generate the answer based on the evaluated information; and
control the display to present information source corresponding to the evaluated information that served as a basis for generating the answer to the user.

3. The system according to claim 1,
wherein the circuitry is configured to:
access a predetermined paper database or information repository to collect related literature;
select the literature based on at least one of a source of the literature, a year of publication, reliability of an author, and a number of citations;
summarize the selected literature;
generate the answer based on summarized content; and
control the display to present at least one of a title of the literature, an author's name, a year of publication, and a journal name.

4. A response generation method comprising:
receiving a question input from a user in natural language;
analyzing the question;
searching for related information;
generating an answer to the question based on the searched information; and
controlling a display to present reference literature that served as a basis for generating the answer to the user.
